(19) United States
(12) Patent Application Publication
(10) Pub. No.: US 2018/0046477 A1
(43) Pub. Date: Feb. 15, 2018

(54) Technique For Scaling An Application Having A Set Of Virtual Machines

(71) Applicant: Telefonaktiebolaget LM Ericsson (publ), Stockholm (SE)

(72) Inventors: Joerg Aelken, Eynatten (BE); Ibtissam El Khayat, Glons (BE); Tommy Lindgren, Lidingö (SE)

(21) Appl. No.: 15/557,537

(22) PCT Filed: Apr. 2, 2015
(86) PCT No.: PCT/EP2015/057344

§ 371 Date: Sep. 12, 2017

(51) Int. Cl. G06F 9/455; G06F 11/30; G06F 11/34; G06F 9/50

(52) U.S. Cl. CPC G06F 9/45529; G06F 9/5077; G06F 11/302; G06F 11/3428

(57) ABSTRACT

A technique for scaling an application with a set of one or more virtual machines is described. The technique may be performed during runtime of the application and responsive to a determination that a scaling operation is required for the application. That determination can be based on at least one first performance measurement result for the application. A method implementation of the technique comprises calculating a scaling magnitude for the required scaling operation taking into account at least one second performance measurement result for the application. The scaling magnitude is indicative of a resource quantity to be added to or removed from the application. The method further comprises triggering generation of a scaling request. The scaling request is directed at a scaling of the application on the basis of the calculated scaling magnitude.

### TECHNICAL FIELD

The present disclosure generally relates to cloud computing. In particular, a technique for scaling an application having a set of virtual machines is presented. The technique may be practiced in the form of a method, a computer program, an arrangement (e.g., an apparatus or node) and a system.

### BACKGROUND

The workgroup on Network Function Virtualization (NFV) within the European Telecommunications Standard Institute (ETSI) has published recommendations on lifecycle management of Virtualized Network Functions (VNF) in their framework ETSI GS NFV-MAN 001, V1.1.1 (2014-12) entitled NFV Management and Orchestration (MANO). One particular aspect of VNF lifecycle management is VNF elasticity via scaling processes.

The VNF scaling processes defined in the ETSI VNF MANO framework include scale-out/-in and scale-up/-down operations (see, e.g., section B.4.4.). Scale-out/-in operations are directed at changing the capacity of a VNF by means of adding or removing Virtual Machines (VMs). Scale-up/-down operations encompass changing the capacity of a VNF by means of adding or removing infrastructure resources (e.g., in terms of computing, network and storage resources) to or from existing VMs.

The execution of a VNF scaling process is triggered by a system entity detecting the need for a capacity increase or decrease via monitoring Key Performance Indicators (KPIs) of the VNF or of its underlying infrastructure. The behavior of the detection entity is usually configured by means of policies. Current policies to configure the decisions for VNF scaling are based on thresholds for certain KPI types (see, e.g., section B.4.4.3 of the ETSI VNF MANO framework). The monitoring of the KPIs and their comparison against the thresholds enable the detection of threshold passing. For example, in the event of a KPI relaxing below a configured threshold, the need for a capacity decrease is detected and execution of a scale-in or scale-down operation will be triggered.

It has been found that the VNF scaling process as defined in the ETSI VNF MANO framework is not optimal in many aspects. For example, the speed of convergence of the scaling process is strongly varying and difficult to predict. As such, the scaling process does not exhibit a deterministic behavior. Similar problems are also encountered for applications with virtual machines that conform to MANO standards different from the ETSI VNF MANO framework.

### SUMMARY

Accordingly, there is a need for a technique that permits a more efficient scaling of applications having a set of one or more virtual machines.

According to a first aspect, a method of scaling an application having a set of one or more virtual machines is provided. The steps of the method are performed during runtime of the application and responsive to a determination that the scaling operation is required for the application, wherein the determination is based on at least one first performance measurement result obtained for the application. In detail, the method comprised calculating a scaling magnitude for the required scaling operation taking into account at least one second performance measurement result obtained for the application, wherein the scaling magnitude is indicative of a resource quantity to be added to or removed from the application. The method further comprises triggering generation of a scaling request, wherein the scaling request is directed at a scaling of the application on the basis of the calculated scaling magnitude.

In certain variations, the method may also comprise determining, prior to the calculation of the scaling magnitude, that a scaling operation is actually required for the application. That determination can be based on the same performance measurement result that will also be taken into account for the calculation of the scaling magnitude or on a different performance measurement result.

In one variant, an operating target is defined for a performance indicator underlying the second performance measurement result. The performance indicator may, for example, be a load parameter of the application, that is measured to obtain the second performance measurement result. The operating target may generally be an operating point or an operating range for a given performance indicator.

The scaling magnitude may be calculated based on a present (i.e., current) or expected relationship between the performance indicator and the operating target.

An expected relationship between the performance indicator and the operating target may, for example, be derived by extrapolating one, two or more second performance measurement results obtained for the same performance indicator at different points in time.

A scaling factor may be determined from the present or expected relationship between the performance indicator and the operating target. The relationship between the operating target and the performance indicator may be expressed in various ways. As an example, the relationship may be defined as a current or expected deviation of the performance indicator from the operating target.

The scaling factor may generally be taken into account for calculating the scaling magnitude. As an example, the scaling magnitude may be calculated from the scaling factor and a resource quantity presently allocated to the application. In certain variants, the scaling magnitude may be determined by multiplying the presently allocated resource quantity with the scaling factor. The result of this multiplication may be processed further (e.g., offset) to obtain the scaling magnitude.

In certain variants the scaling magnitude is calculated taking into account multiple second performance measurement results obtained for multiple performance indicators. As an example, for each performance indicator a dedicated second measurement result may be obtained. In such a case a dedicated operating target may be defined for each performance indicator. The scaling magnitude may then be calculated based on present or expected relationships between the performance indicators and the associated operating targets.

There may exist a known correlation between the second performance measurement result and the resource quantity to be added to or removed from the application. As an example, the correlation may be a functional (e.g., essentially linear) relationship or a mapping. The correlation may have been determined prior to runtime of the application (e.g., via an empirical approach that can be based on measurements).

The known correlation may be taken into account in the calculation of the scaling magnitude. As an example, the scaling magnitude may be determined from the correlation and the relationship between the operating target and the performance indicator.

The second performance measurement result is in one example indicative of a system performance of the application The second measurement result may thus have been obtained by aggregating individual performance measurements over the set of virtualized machines. As an example, for each individual virtual machine in the set a dedicated individual performance measurement may be performed. The resulting individual performance measurement results can be aggregated (e.g., added, averaged, etc.) so as to obtain the (“final”) second performance measurement result that will be taken into account in the scaling magnitude calculation.

At least one of the first measurement result and the second measurement result may be indicative of a load of the application. Additionally, or in the alternative, at least one of the first measurement result and the second measurement result may be independent from the number of virtual machines associated with the application. As explained above, averaging of individual performance measurement results obtained for each individual virtual machine could be applied to that end.

The determination that a scaling cooperation is required and the calculation of the scaling magnitude may be performed on the basis of one and the same performance measurement result or set of performance measurement results. As such, the (first) measurement result underlying the determination that the scaling operation is required may be used as the (second) measurement result that is taken into account upon calculating the scaling magnitude.

As said, the method presented herein may further comprise determining that a scaling operation is required. That determination may be performed in various ways, for example by subjecting the first performance measurement result to at least one threshold decision. In some variants, a lower threshold and an upper threshold for the first performance measurement result may be defined. The determination may in certain variants also be performed based on the operating target for the performance indicator. As an example, it may be determined that a scaling operation is required upon detection of a predefined deviation of the first performance measurement result from the operating target.

The operating target (e.g., the operating point or operating range) for the performance indicator may lie between the lower threshold and the upper threshold. In other variants, the operating target may at least partially lie below the lower threshold or above the upper threshold. There may exist a predefined relationship between the operating target for the performance indicator on the one hand and at least one of the lower threshold and the upper threshold on the other.

The method may further comprise verifying the calculated scaling magnitude. Moreover, the method may optionally comprise adjusting the calculated scaling magnitude dependent on a result of the verification. The scheduling request may be triggered to be generated such that it is indicative of the adjusted scaling magnitude.

The verification of the calculated scaling magnitude may be performed in various ways, for example by comparing the calculated scaling magnitude with at least one configuration parameter. A threshold decision may be applied in this regard.

The at least one configuration parameter may be selected from a parameter set comprising a maximum number of allowed virtual machines for the application, a minimum number of allowed virtual machines for the application, a maximum amount of allowed infrastructure resources for an individual virtual machine, and a minimum amount of allowed infrastructure resources for an individual virtual machine. As such, the resource quantity may be indicative of a number of virtual machines to be added to or removed from the application. Alternatively, or in addition, the resource quantity may be indicative of infrastructure resources for the virtual machines to be added to or removed from (e.g., per virtual machine) the application.

Also provided is a computer program product comprising program code portions for performing the steps of any of the methods and method steps presented herein when the computer program product is executed by at least one computing device (e.g., a processor or a distributed set of processors). The computer program product may be stored on a computer-readable recording medium, such as a semiconductor memory, a CD-ROM, DVD, and so on.

According to a still further aspect, an arrangement configured to trigger scaling of an application having a set of one or more virtual machines is presented. The arrangement comprises at least one processor configured to perform dedicated operations during runtime of the application and responsive to a determination that a scaling operation is required for the application, wherein the determination is based on at least one first performance measurement result obtained for the application. Specifically, the processor is configured to calculate a scaling magnitude for the required scaling operation taking into account at least one second performance measurement result obtained for the application, wherein the scaling magnitude is indicative of a resource quantity to be added to or removed from the application. The processor is further configured to trigger generation of a scaling request, wherein the scaling request is directed at a scaling of the application based on the calculated scaling magnitude.

The application may be configured as a VNF. Moreover, the arrangement may be configured as a VNF Manager (VNFM). The VNF and VNFM may conform to ETSI GS NFV-MAN 001, V1.1.1 (2014-12). It should be noted that the arrangement could also be configured in any other manner and is thus not limited to being implemented in a telecommunications scenario.

The arrangement may generally be configured to perform any of the methods and method steps presented herein. Moreover, the arrangement may be configured as an apparatus, a network node or a set of network nodes.

Also provided is a system comprising the arrangement presented herein and the application having the set of one or more virtual machines. The system may belong to a telecommunications cloud system. The telecommunications cloud system may further comprise at least one of a Radio Base Station (RBS) function, an Evolved Packet Core (EPC) function, an Internet Protocol Multimedia Subsystem (IMS) core function, and one or more other functions running on the set of virtual machines.

### BRIEF DESCRIPTION OF THE DRAWINGS

Further details, aspects and advantages of the present disclosure will become apparent from the following description of exemplary embodiments and the accompanying drawings, wherein:

FIG. 1 schematically illustrates an embodiment of a telecommunications cloud system in which the present disclosure may be implemented;

FIG. 2 schematically illustrates an embodiment of a triggering arrangement;

FIG. 3 illustrates a flow diagram of a method embodiment performed by the triggering arrangement of FIG. 2;

FIG. 4 schematically illustrates an embodiment of an application underlying a scaling operation;

FIG. 5 schematically illustrates a signalling diagram into which embodiments of the present disclosure may be integrated;

FIG. 6 illustrates a further flow diagram of a method embodiment;

FIG. 7 schematically illustrates an embodiment of KPI aggregation; and

FIG. 8 illustrates a diagram underlying an exemplary scaling scenario.

### DETAILED DESCRIPTION

In the following description, for purposes of explanation and not limitation, specific details are set forth, such as specific network nodes, network configurations, communication protocols, and so on, in order to provide a thorough understanding of the present disclosure. It will be apparent to one skilled in the art that the present disclosure may be practiced in other embodiments that depart from these specific details. For example, while the following embodiments will partially be described in connection with exemplary cloud architectures and an exemplary ETSI recommendation, it will be appreciated that the present disclosure may also be practiced in connection with other cloud architectures and other cloud management and orchestration approaches. It will also be appreciated that the present disclosure is not limited to be applied in connection with telecommunications systems. Rather, the present disclosure could, for example, also be implemented in connection with online sales or other enterprise applications.

Those skilled in the art will further appreciate that the steps, services and functions explained herein below may be implemented using individual hardware circuitry, using software functioning in conjunction with a programmed micro-processor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories are encoded with one or more programs that perform the steps, services and functions disclosed herein when executed by the one or more processors.

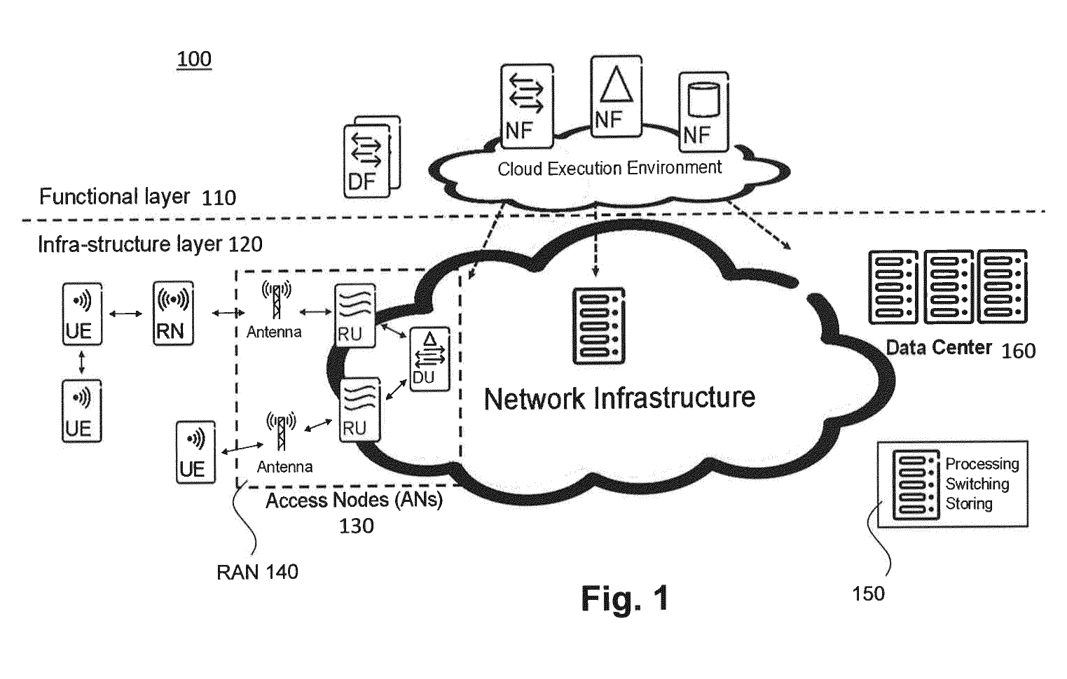

FIG. 1 illustrates an embodiment of a possible cloud architecture 100 of a 5^{th} Generation (5G) telecommunications network system in which the present disclosure may be implemented. The cloud architecture 100 logically separates network functions potentially running on virtualized hardware (functional layer 110 in FIG. 1) from the infra-structure or hardware layer 120 containing the physical nodes in the 5G network system.

The functional layer 110 contains the functions (Network Functions (NF) and Dedicated Functions (DF)) performed by the 5G network system including tasks like mobility, security, routing, baseband processing, etc. Many but not necessarily all of these NFs will be performed by software running on virtualized hardware. Some of these NFs running on virtualized hardware will utilize Application Program Interfaces (API) provided by an execution environment to be able to control functionalities executed in hardware such as Service Defined Network (SDN) switches, hardware acceleration and so on.

Since at least some of these NFs are virtualized (VNFs), they are not tied to a specific hardware node. That is, they can be executed in different places within the network system depending on the given deployment scenario and requirements. This approach makes it possible to, for instance, distribute in a flexible way gateway functionalities closer to radio access nodes 130 when needed for particular services, while supporting more centralized gateways for other services. In theory this also makes it possible to dynamically re-configure the network system based on ongoing services or load. However, in the 2020 time frame it is still expected that time critical functions such as baseband processing today performed by dedicated hardware in the access nodes 130 (implementing DFs) will in most cases continue to do so.

The infrastructure (hardware) layer 120 of the cloud architecture 100 contains radio nodes including user terminals (also called User Equipment, UEs), relay nodes (including wireless MTC-gateways or self-backhauled nodes) and one or more RANs 140 with the access nodes 130. In FIG. 1, the access nodes 130 are separated in antenna, Radio Unit (RU) and Digital Unit (DU). Further, the infrastructure layer 120 comprises network nodes including processing, switches/routers and storage nodes 150 and one or more data centers 160. The nodes 150 may, for example, be configured to host EPC services or functions.

The cloud model underlying cloud architectures, such as the architecture 100 shown in FIG. 1, can be divided into four layers: the hardware layer (1), the infrastructure layer (2), the platform layer (3) and the application layer (4). Each higher layer builds on top of the features and services provided by the lower layers.

The hardware layer typically refers to the data center(s) 160 and other core infrastructure nodes 150 (see FIG. 1). The infrastructure is offered as infrastructure-as-a-service (IaaS) at layer 2. Then, at the layer 3, the platform layer, high-level platforms and environments are provided to develop software or services often referred to as platform-as-a-service (PaaS). These platforms usually take the form of operating systems and/or software frameworks. The point is to shield from dealing with the underlying complexities of the infrastructure entities such as Virtual Machine (VM) containers and raw storage blocks.

Finally, at the application layer, there are installed generally one or more service provider applications providing, in the present embodiment, telecommunications services and, in more general realizations, business applications, web services, multimedia and gaming services. All of these qualify as software-as-a-service (SaaS) in the cloud paradigm terminology. The scaling approach presented herein may be performed in relation to an application residing on the application layer.

Due to the high availability requirements in the cloud architecture 100 of FIG. 1, it is critical to develop techniques for service assurance to fulfill those requirements, but also many other requirements. This objective typically involves continuous monitoring of relevant KPIs relating, for example, to a specific SLA for a given service (e.g., an RBS service within the RAN 140), analyzing the data for finding abnormal trends and anomalies and triggering the suitable cloud orchestration actions, such as scaling operations, in case of any violations.

For example, during peak hours extra capacities are required by critical applications supporting, for example, the RAN 140. On the other hand, during off-peak hours the capacity requirement may drastically relax. To cope with these and other load fluctuations in the network system of FIG. 1, efficient scaling solutions as presented herein may be applied.

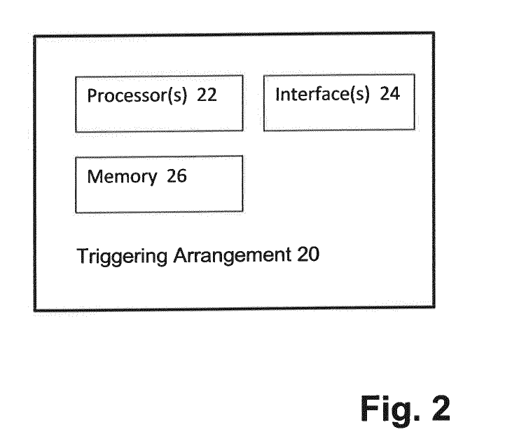

FIG. 2 illustrates an embodiment of a triggering arrangement 20 configured to trigger scaling of an application having a set of one or more VMs, such as an application within the network system shown in FIG. 1 or any other application. The arrangement 20 can be configured as a network node or network function, or as a distributed set of network nodes and network functions. The arrangement 20 could also (fully or partially) reside on a UE.

As shown in FIG. 2, the triggering arrangement 20 comprises at least one processor 22, at least one interface 24 and at least one memory 26. The at least one processor 22 is configured to perform processing operations under control of program code stored in the memory 26. The one or more interfaces 24 are configured as software and/or hardware interfaces. Specifically, the one or more interfaces 24 may be configured to receive and send data and control signaling. In certain variants of the present disclosure, the one or more interfaces 24 are configured to receive performance measurement results and to send scaling requests or control signaling that triggers generation of such scaling requests.

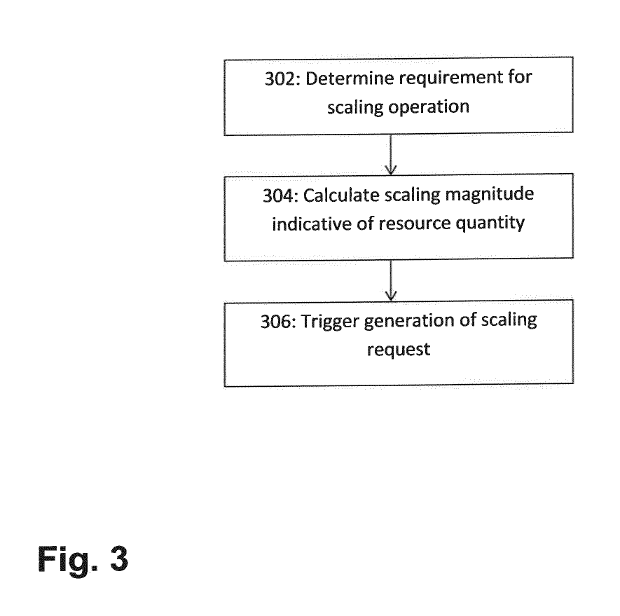

An exemplary mode of operation of the triggering arrangement 20 illustrated in FIG. 2 will now be described with reference to the flow diagram illustrated in FIG. 3. The operation targets at triggering scaling of an application having a set of one or more VMs.

In an (optional) initial step 302, the at least one processor 22 of the triggering arrangement 20, or any other entity, determines that a scaling operation is required for the application with the one or more VMs. That determination may be based on at least one first performance measurement result obtained for the application. The first performance measurement result may have been received by the triggering arrangement 20 via the one or more interfaces 24. Step 302 is performed during runtime of the application.

The determining step 302 may include subjecting the first performance measurement result to one or more threshold decisions. Specifically, a lower threshold and an upper threshold may be defined (e.g., in the memory 26). It may thus be determined in step 302 that a scaling operation is required if the first performance measurement result exceeds the upper threshold or falls below the lower threshold. Alternatively, the determination in step 302 whether a scaling operation is required could also be based on a deviation of the first performance measurement result from a predefined operating target for a performance indicator. Details regarding the operating target will be described below.

Responsive to the determination in step 302 that a scaling operation is required, the at least one processor 22 calculates a scaling magnitude for the required scaling operation in step 304. The calculation in step 304 takes into account at least one second performance measurement result for the application. The second performance measurement result may be identical or different from the first performance measurement result processed in step 302. The second performance measurement result may also have been received via one or more interfaces 24.

The scaling magnitude calculated in step 304 is indicative of a resource quantity to be added to or removed from the application. As an example, the resource quantity may be indicative of a number of VMs to be added to or removed from the application. As a further example, the resource quantity may be indicative of an amount of infrastructure resources (e.g., in terms of one or more of computing, storage and networking resources) to be added to or removed from one or more of the VMs in the set.

In an optional step not depicted in FIG. 3, the scaling magnitude calculated in step 304 may be verified by comparing the calculated scaling magnitude with at least one configuration parameter, such as one or more of a maximum number of allowed VMs for the application, a minimum number of allowed VMs for the application, a maximum amount of allowed infrastructure resources for an individual VM, and a minimum amount of allowed infrastructure resources for an individual VM. Based on the result of the comparison, the scaling magnitude calculated in step 304 can be adjusted so as to meet the one or more configuration parameters.

In a further step 306, generation of a scaling request is triggered by the triggering arrangement 20. The scaling request generated in response to the triggering operation is directed at a scaling of the application on the basis of the calculated scaling magnitude. Step 306 encompasses the case where the calculated scaling magnitude is adjusted responsive to its verification (as the adjusted scaling magnitude will still be based on the scaling magnitude calculated in step 304).

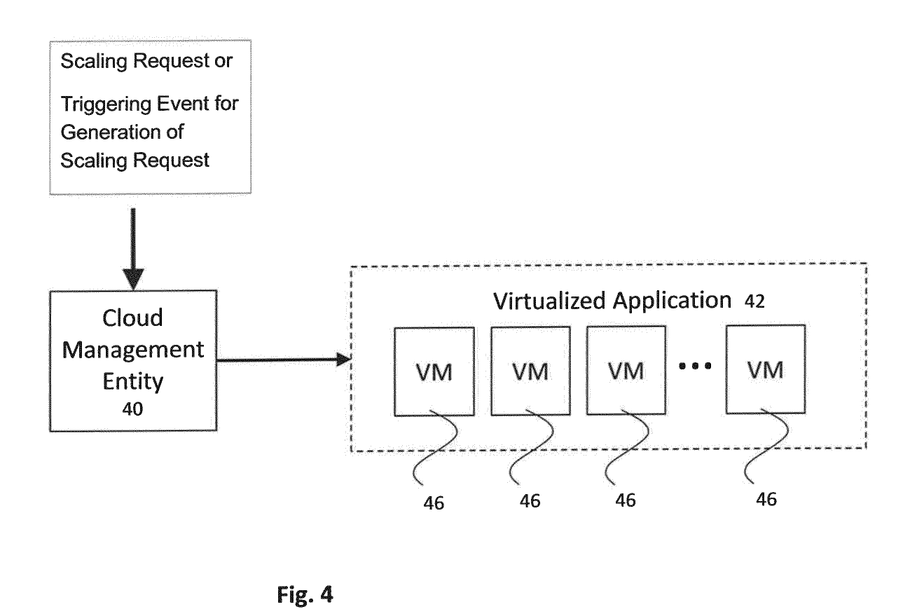

Responsive to the triggering step 306, the scaling request will either be generated locally within the triggering arrangement 20 or by any other entity. As such, the triggering arrangement 20 may send via the one or more interfaces 24 either a triggering event for the scaling request or the scaling request as such to another entity in charge of actually scaling the application, such as a cloud management entity. FIG. 4 schematically illustrates such a cloud management entity 40 in control of a virtualized application, or simply application, 42. As shown in FIG. 4, the application 42 comprises multiple VMs 46. The cloud management entity 40 and the application 42 may belong to the functional layer 110 of the cloud architecture 100 shown in FIG. 1.

The cloud management entity 40 will receive the scaling request or the triggering event for generation of a scaling request either directly from the triggering arrangement 20 or from an entity located between the triggering arrangement 20 and the cloud management entity 40, see FIG. 4. The scaling request or the triggering event will comprise the scaling magnitude as calculated in step 304 that has, optionally, been adjusted responsive to the verification step.

Responsive to receipt of the scaling request or the triggering event, the cloud management entity 40 adds or removes one or more VMs 46 from the application 42 depending on the indicated scaling magnitude. Alternatively, or in addition, the cloud management entity 40 adds or removes infrastructure resources to or from one or more of the VMs 46 dependent on the indicated scaling magnitude.

A VM 46 may generally be constituted by a (virtualized) computing resource. Thus, creation or generation of a VM 46 may refer to deployment or allocation of the associated computing resource. To each computing resource, networking resources and storage resources can be added (e.g., associated, allocated or connected) on demand. Different technologies exist to allocate computing resources and exposed them as VMs 46. Such technologies include a hypervisor as hardware abstraction layer, containers (e.g., Linux containers), PaaS frameworks, and a so-called bare metal virtualization. In the ETSI Framework, the term is used to designate a virtualized application 42. A deployed VNF typically consists of multiple instances of one or more (typically different) VM types, where each VM type runs its own, dedicated function.

In certain variants, the calculation step 304 in FIG. 3 may take into account an operating target (e.g., an operating point or operating range) defined for a performance indicator underlying the second performance measurement result that is taken into account in the scaling magnitude calculation. As such, the scaling magnitude may be calculated in step 304 based on a present or expected relationship between the performance indicator (for which the second performance measurement result has obtained) and the operating target. In case multiple second performance measurement results (e.g., for different performance indicators) are taken into account upon calculating the scaling magnitude in step 304, for each performance indicator a dedicated operating target may be defined.

The operating target and related parameters may be specified in different ways and may be stored in the memory 26 for being accessed by the one or more processors 22 of the triggering arrangement 20 (see FIG. 2). As an example, an operating target may be a dedicated performance indicator target point or target range of a predefined scaling policy configuration. Alternatively, or in addition, the operating target may be calculated from one or more threshold values that are analyzed in connection with determining whether or not there exists requirement for a scaling operation (see step 302 in FIG. 3). As an example, a predefined scaling policy configuration stored in the memory 26 may define offset values or any functional relationship to be applied to the one or more threshold values to calculate the one or more operating targets. In certain variants, the predefined policy configuration could also define an operating range for each performance indicator that is taken into account in the calculation step 304.

The scaling magnitude may be calculated based on a present or expected relationship between the respective performance indicator and the respective operating target. As an example, the present relationship may simply be determined by analyzing a deviation of the (current) second performance measurement result from the operating target. An expected relationship may be determined by extrapolating a number of (previous) second performance measurement results into the future and by analyzing a deviation of the extrapolated value from the operating target.

In certain variants, a scaling factor may be determined from the present or expected relationship between the performance indicator and the operating target. In such a case the scaling magnitude may be calculated from the scaling factor and a resource quantity presently allocated to the application (e.g., using a multiplication operation).

For a particular performance indicator, the scaling factor may be determined from the associated operating target (e.g., as stored in the memory 26 as part of a predefined scaling policy configuration). Alternatively, or in addition, the scaling factor may be determined from the present or expected relationship between the performance indicator and the operating target.

In an exemplary implementation compliant, for example, with the ETSI framework, the expected relationship (e.g., deviation) is used for scale-up and scale-out operations. Extrapolation in connection with scale-down and scale-in may be used only if a reaction time for the scale-down/scale-in operation is very slow and the point of extrapolation is not further than the time to complete the associated scaling action. By specifying the operating target for each KPI of an application 42 for each of a scale-out, scale-in, scale-up and scale-down operation individually, an operator can configure the desired behavior of the application 42 concerning the desired load and resource utilization.

In certain scenarios, a dedicated operating target for each performance indicator (e.g., KPI) of interest and for each configured scaling operation (e.g., one of more of scale-out, scale-in, scale-up and scale-down) may be provided. The one or more operating targets (or parameters suitable to derive the one or more operating targets) may be stored in the memory 26 for use by the one or more processors 22 of the triggering arrangement 20 (see FIG. 2). The corresponding parameter set for deriving an operating target may include one or more of an operating point and a maximum permissible deviation relative thereto (i.e., to define an operating range), minimum and maximum values of the operating range (e.g., relative to one or more thresholds utilized in the determination step 302 of FIG. 3) and a simple target operating point. Based on these configuration parameters (that define a particular scaling policy) and runtime data (e.g., performance measurement results obtained for one or more KPIs), the scaling magnitude can then be calculated in step 304 as generally explained above. Further configuration data stored in the memory 26 and used for determining the scaling magnitude may include the maximum/minimum number of allowed VMs 46 and of allowed infrastructure resource for an individual VM 46 as discussed above.

The runtime data in terms of the (first and second) performance measurement results may continuously be received at runtime of the application 42. Further, the calculation of the scaling magnitude in step 304 may also take into account runtime information on the number of active VMs 46 in the application 42 and the actual amount of allocated infrastructure resources per application 42 or VM 46 in the application 42.

In the following, the embodiments described above will exemplarily be put in the larger context of ETSI GS MFV-MAN 001, V1.1.1 (2014-12). It will appreciated that the following details of exemplary scaling approaches could likewise be applied in connection with other cloud management and orchestration approaches.

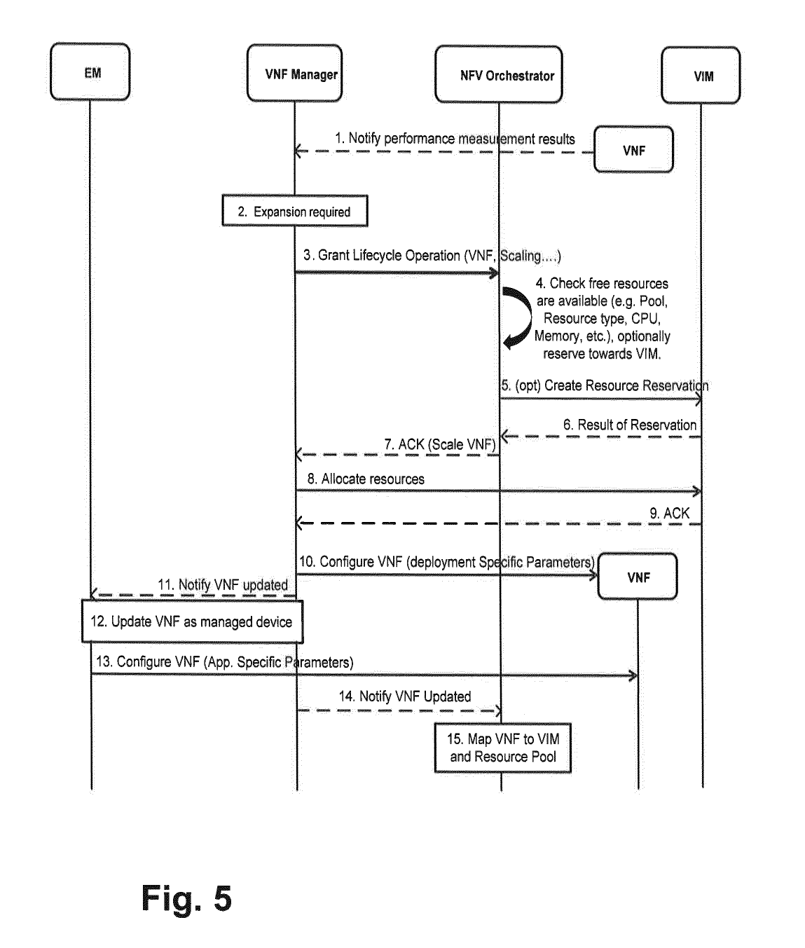

FIG. 5 illustrates an embodiment of a signaling diagram in which the present disclosure can be embedded. The signaling diagram is based on Fig. B.13 of the ETSI framework and shows the signaling between the following components: Element Management (EM), VNFM, NFV Orchestrator (NFVO), and Virtualized Infrastructure Manager (VIM).

In step 1, the VNFM is continuously informed during runtime of the VNF (e.g., in the form of the application 42 illustrated in FIG. 4) about performance measurement results pertaining to one or more KPIs. The VNFM collects the measurement results and detects in step 2 the requirement for a scaling operation and also calculates a scaling magnitude indicative of a required resource quantity (e.g., as generally described with reference to FIG. 3 above). The VNFM may detect a requirement for a scaling operation from a capacity shortage in the VNF that requires an expansion (e.g., an addition of resources to the VNF).

The VNFM then generates a scaling request comprising the calculated scaling magnitude and sends the scaling request in step 3 to the NFVO for VNF expansion using the operation Grant Lifecycle Operation of the VNF Lifecycle Operation Granting interface. In step 4, the NFVO takes a scaling decision and checks the scaling magnitude in the resource request received from the VNFM against its capacity database for free resource availability. The remaining steps 5 to 15 in the signaling diagram of FIG. 5 are generally in line with the ETSI framework and will therefore not be described in greater detail herein.

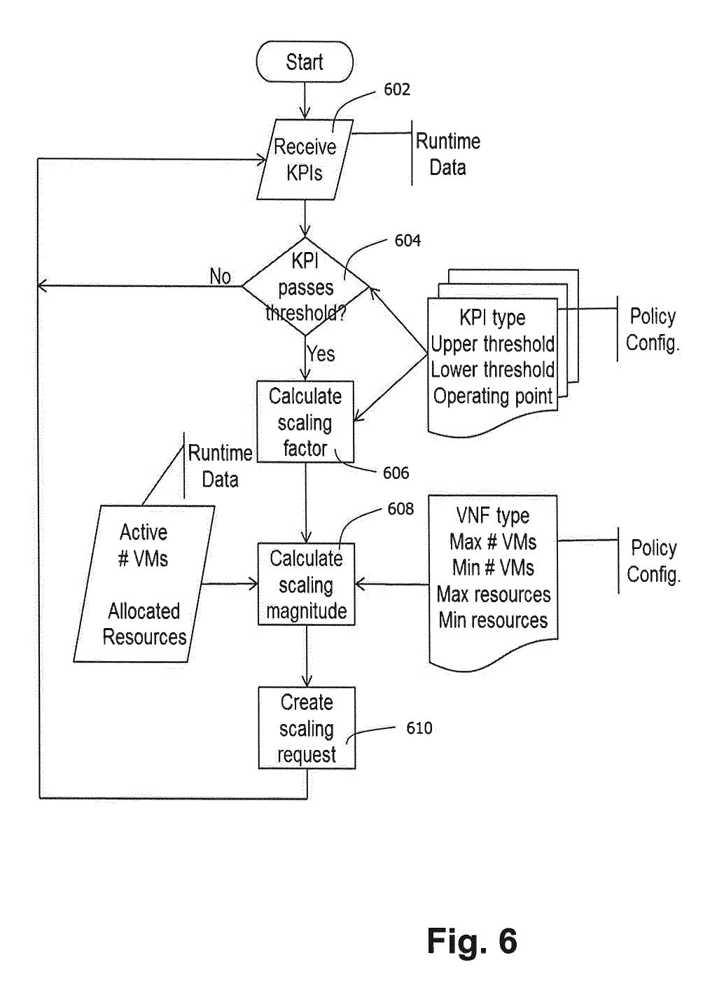

FIG. 6 illustrates a further flow diagram of a method embodiment that may be performed by the triggering arrangement in FIG. 2, and, in particular by the VNFM (e.g., in step 2 of FIG. 5).

Initially, in step 602, runtime data are received. The runtime data include performance measurement results for multiple KPIs.

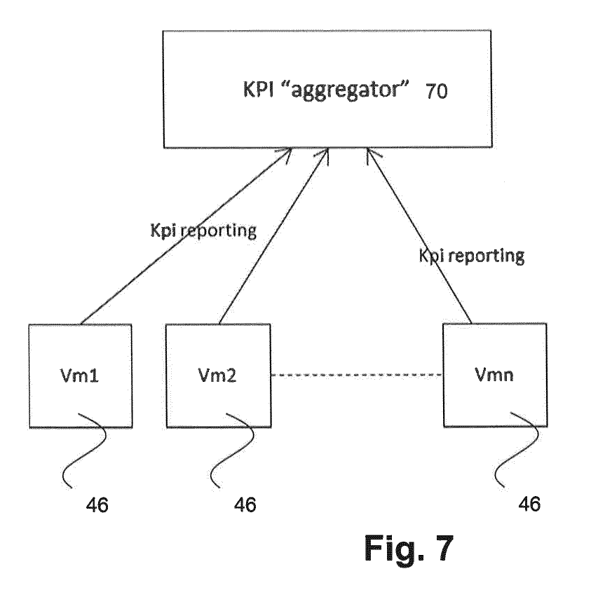

The measurement results received in step 602 have been previously aggregated as generally illustrated in FIG. 7. That is, each VM 46 in the application 42 reports its local performance measurement result obtained for a particular KPI to a KPI aggregator 70. The KPI aggregator 70 aggregates the reported measurement results such that the resulting aggregated measurement result is independent of the number of reporting VMs 46. As an example, the KPI aggregator may apply an averaging procedure.

Then, in step 604, the individual (aggregated) measurement results for the various KPIs are individually subjected to a threshold decision to determine the requirement of a scaling operation (in accordance with step 302 of FIG. 3). For each KPI a lower threshold and an upper threshold may be defined as explained above. In case no threshold violation is detected in step 604, the method loops back to step 602.

In case it is determined in step 604 that for at least one KPI the associated upper threshold or lower threshold is passed, the method proceeds to step 606. In step 606 a scaling factor is calculated. There exist various algorithmic options for calculating the scaling factor.

One exemplary algorithm assumes a linear functional relationship between the performance measurement results and the number of VMs 46 or allocated infrastructure resources of the VMs 46 within the application 42. For each KPI type value KPIᵢ passing an associated threshold value (as determined in step 604), a KPI type specific scaling factor SFᵢ can be calculated as follows:

$${SF}_{i} = \frac{abs ( {KPI}_{i} {OP}_{i} )}{{OPi}_{\cdot l}}$$

wherein OPᵢ denotes the operating point value for this KPI type. In a simple form, the scaling factor SF is set to the maximum of the individual scaling factors SFᵢ in case of an exemplary scale-out operation. That is

SF=max(SFᵢ)

In its simple form, the scaling factor SF is set to the minimum of the individual scaling factors SFᵢ in case of a scale-in operation. In a similar manner, scale-up and scale-down operations are handled. In general, different weights could be given to the different KPIs. The scaling factor SF may then be impacted by these weights.

Of course, other algorithms could be used as well for calculating the scaling factor. Generally, there will often be a way to define one or more KPIs that scale linearly with the number of VMs 46 or the amount of allocated resources. Another way of defining the correlation of the performance measurement results and the number of VMs 46 or allocated infrastructure resources comprises running the application 42 with different numbers of VMs or different amounts of allocated infrastructure resources and different loads, and capturing the correlation between the performance measurement results and the required number of VMs 46 or required amount of infrastructure resources. These processes are performed prior to runtime of the application 42, for example, during an installation phase of the system. As a result, a functional relationship or a mapping between the performance measurement results and the required resource quantity to be added or to be removed can be determined.

From step 606, the process illustrated in FIG. 6 moves to step 608 and the calculation of the scaling magnitude. Steps 606 and 608 generally correspond to step 304 in FIG. 3.

In detail, the scaling factor determined in step 606 is multiplied with the number of active VMs 46 or the amount of allocated infrastructure resources. The result of this multiplication is rounded up or down to an integer value so as to obtain the scaling magnitude. The scaling magnitude will thus be indicative of the particular resource quantity to be added or removed from the application.

In order to avoid exceeding or falling below a configured maximum or minimum size of the application 42 in terms of the number of VMs 46 or amount of infrastructure resources, the scaling magnitude calculated in step 608 can be verified (not shown in FIG. 6). The verification process may include the calculation of the potential new number of VMs 46 or amount of infrastructure resources taking into account the currently deployed resource quantity and adding or removing resource quantity in accordance with scaling magnitude to or from the currently deployed resource quantity. If the resulting number of VMs 46 or amount of infrastructure resources violates the corresponding maximum or minimum conditions, the scaling magnitude will be adjusted accordingly (e.g., limited to the particular maximum or minimum value that is passed).

Then, in step 610, the scaling request is generated that includes the calculated and, potentially, adjusted scaling magnitude. The processing of the scaling request may then be performed as generally illustrated in FIG. 5 (steps 4 to 15), and the method loops back to step 602. In this regard, a “protection period” in which no further scaling request is or can be triggered might be implemented.

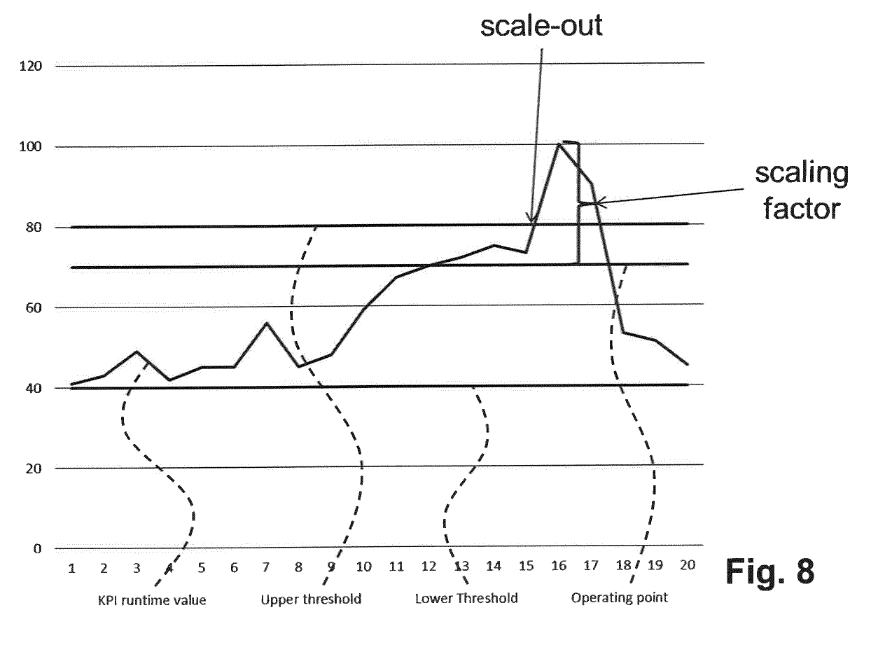

In the following, an actual example of a scale-out operation will be described with reference to the exemplary diagram shown in FIG. 8. FIG. 8 illustrates, for a particular KPI, an upper threshold and a lower threshold for a performance measurement result (KPI runtime value) that is subjected to the determination step 302 in FIG. 3 or 604 in FIG. 6. Also, a dedicated operating point underlying the calculation of the scaling magnitude in step 304 or 608 is illustrated.

For the purpose of the following example, a “VM load KPI” is defined as the arrival rate of requests in an individual VM 46 divided by the maximum number of requests the individual VM 46 can handle:

$${Load}_{VM} = \frac{rate of coming requests}{max Req}$$

The arrival rate will be measured over a configurable time interval. The maximum number of requests one VM 46 can handle is supposed to be a known value (e.g., a predefined number).

To determine the system performance of the set of VMs 46 defining a particular application 42 (see FIG. 4), the scaling factor SF is derived as an average of the KPI values (i.e., measurement results) obtained for a number num_VM of individual VMs 46 in the application 42. It will be assumed here that all VMs are of the same “size” (i.e., can handle the same load in terms of incoming requests). Then, a “load system KPI” can be expressed as:

Load_sys=(Σₖ₌₀^{num}^{_{VM}}Load_{VM}_{ₖ})/num_{VM},

where Load_{VM}_{_}ₖ is the load of the k'th VM 46.

In the example illustrated in FIG. 8 we consider that:
the upper threshold (as applied, e.g., in steps 302 and 604) is set to 80%
the lower threshold (as applied, e.g., in steps 302 and 604) is set to 40%
the operating point (as applied, e.g., in steps 304 and 608) is set to 70%

Let us suppose that we have a system with three VMs 46 (i.e., n=3 in FIG. 7). Each VM 46 is capable of handling a maximum of 100 requests/sec. Let us also suppose that, just before an increase of load, all the VMs 46 are handling 60 requests/sec each. Let us further suppose that there will be a load increase of 66% (i.e, 120 requests/sec coming more into the application 42). In the scenario of FIG. 7, Vm1 ends up with 110 requests/sec, VM2 with 90 requests/sec and VM3 with 100 requests/sec (there is no control on the load balancing in the present example). Thus, Vm1, Vm2 and Vm3 will send load KPI values of 1.1, 0.9, and 1, respectively, to the KPI aggregator 70.

The KPI aggregator 70, based on these three values, calculates the system load KPI value as defined above to equal:

Load_sys=1.

It is this value that enters as measurement result step 602 in FIG. 6 (see also FIG. 8). It will thus be determined in step 604 that the upper threshold (i.e., 80 requests/sec) is passed. The scaling factor is then determined in step 606 to equal:

SF=(1−0.7)/0.7=0.43

The number of VMs 46 to be added to the application 42 (i.e., the scaling magnitude) can then be calculated in step 608 by multiplying that scaling factor SF with the current number of VMs 46 utilized by the application 42:

Ceil(SF*current_number_VM)=Ceil(0.43*3)=2

This means that the scaling request sent in step 610 will indicate that two VMs 46 have to be newly added to the application 42.

As has become apparent from the above description of exemplary embodiments, the behavior of applications with one or more VMs can be controlled more deterministic in terms of load and resource utilization. In certain variants, an operator is able to specify desired operating targets for the application. Moreover, the capacity of an application can be adapted faster to the current load, and will also converge faster to a desired operating target.

The present disclosure may, of course, be carried out in other ways than those specifically set forth herein without departing from the scope of the claims appended hereto. Thus, the present embodiments are to be considered in all respects as illustrative and not restrictive, and all changes coming within the scope the appended claims are intended to be embraced therein.

1-24. (canceled)

25. A method of triggering scaling of an application having a set of one or more virtual machines, wherein the method comprises the following steps performed during runtime of the application and responsive to a determination that a scaling operation is required for the application, wherein the determination is based on at least one first performance measurement result obtained for the application:
calculating a scaling magnitude for the required scaling operation taking into account at least one second performance measurement result obtained for the application, wherein the scaling magnitude is indicative of a resource quantity to be added to or removed from the application; and
triggering generation of a scaling request, wherein the scaling request is directed at a scaling of the application based on the calculated scaling magnitude.

26. The method of claim 25, wherein:
an operating target is defined for a performance indicator underlying the second performance measurement result; and
the scaling magnitude is calculated based on a present or expected relationship between the performance indicator and the operating target.

27. The method of claim 26, wherein:
a scaling factor is determined from the present or expected relationship between the performance indicator and the operating target; and
the scaling magnitude is calculated from the scaling factor and a resource quantity presently allocated to the application.

28. The method of claim 26, wherein:
the scaling magnitude is calculated taking into account multiple second performance measurement results obtained for multiple performance indicators, wherein for each performance indicator a dedicated operating target is defined; and
wherein the scaling magnitude is calculated based on present or expected relationships between the performance indicators and the associated operating targets.

29. The method of claim 25, wherein
there exists a known correlation between the second performance measurement result and the resource quantity to be added to or removed from the application; and
the correlation is taken into account in the calculation of the scaling magnitude.

30. The method of claim 29:
wherein an operating target is defined for a performance indicator underlying the second performance measurement result;
wherein the scaling magnitude is calculated based on a present or expected relationship between the performance indicator and the operating target; and
wherein the scaling magnitude is determined from the correlation and the relationship between the operating target and the performance indicator.

31. The method of claim 29, wherein the correlation is a functional relationship or a mapping.

32. The method of claim 29, wherein the correlation has been determined prior to runtime of the application.

33. The method of claim 25, wherein the second performance measurement result is indicative of a system performance of the application having the set of virtual machines.

34. The method of claim 33, wherein the second performance measurement result has been obtained by aggregating individual performance measurements over the set of virtual machines.

35. The method of claim 25, wherein at least one of the first measurement result and the second measurement result is indicative of a load of the application.

36. The method of claim 25, wherein at least one of the first measurement result and the second measurement result is independent of the number of virtual machines associated with the application.

37. The method of claim 25, wherein the first measurement result is used as the second measurement result in the calculation of the scaling magnitude.

38. The method of claim 25, further comprising determining that a scaling operation is required by subjecting the first performance measurement result to at least one threshold decision.

39. The method of claim 38:
wherein an operating target is defined for a performance indicator underlying the second performance measurement result;
wherein the scaling magnitude is calculated based on a present or expected relationship between the performance indicator and the operating target; and
wherein a lower threshold and an upper threshold are defined, and wherein the operating target lies between the lower threshold and the upper threshold.

40. The method of claim 25, further comprising
verifying the calculated scaling magnitude; and
adjusting the calculated scaling magnitude dependent on a result of the verification;
wherein the scheduling request is triggered to be generated to be indicative of the adjusted scaling magnitude.

41. The method of claim 40, wherein verifying the calculated scaling magnitude comprises comparing the calculated scaling magnitude with at least one configuration parameter.

42. The method of claim 25, wherein the resource quantity is indicative of at least one of a number of virtual machines and an amount of infrastructure resources of the virtual machines.

43. The method of claim 41:
wherein the resource quantity is indicative of at least one of a number of virtual machines and an amount of infrastructure resources of the virtual machines;
wherein the at least one configuration parameter is selected from the parameter set comprising:
a maximum number of allowed virtual machines for the application;
a minimum number of allowed virtual machines for the application;
a maximum amount of allowed infrastructure resources for an individual virtual machine;
a minimum amount of allowed infrastructure resources for an individual virtual machine.

44. A non-transitory computer readable recording medium storing a computer program product for triggering scaling of an application having a set of one or more virtual machines, the computer program product comprising software instructions which, when run on processing circuitry of a computing device, causes the computing device to perform the following steps during runtime of the application and responsive to a determination that a scaling operation is required for the application, wherein the determination is based on at least one first performance measurement result obtained for the application:
calculate a scaling magnitude for the required scaling operation taking into account at least one second performance measurement result obtained for the application, wherein the scaling magnitude is indicative of a resource quantity to be added to or removed from the application; and
trigger generation of a scaling request, wherein the scaling request is directed at a scaling of the application based on the calculated scaling magnitude.

45. An arrangement configured to trigger scaling of an application having a set of one or more virtual machines, the arrangement comprising:
processing circuitry;
memory containing instructions executable by the processing circuitry whereby the arrangement is operative to perform the following operations during runtime of the application and responsive to a determination that a scaling operation is required for the application, wherein the determination is based on at least one first performance measurement result obtained for the application:
calculate a scaling magnitude for the required scaling operation taking into account at least one second performance measurement result obtained for the application, wherein the scaling magnitude is indicative of a resource quantity to be added to or removed from the application; and
trigger generation of a scaling request, wherein the scaling request is directed at a scaling of the application based on the calculated scaling magnitude.

46. A system, comprising
an arrangement configured to trigger scaling of an application having a set of one or more virtual machines, the arrangement comprising:
processing circuitry;
memory containing instructions executable by the processing circuitry whereby the arrangement is operative to perform the following operations during runtime of the application and responsive to a determination that a scaling operation is required for the application, wherein the determination is based on at least one first performance measurement result obtained for the application:
calculate a scaling magnitude for the required scaling operation taking into account at least one second performance measurement result obtained for the application, wherein the scaling magnitude is indicative of a resource quantity to be added to or removed from the application; and
trigger generation of a scaling request, wherein the scaling request is directed at a scaling of the application based on the calculated scaling magnitude.
the application having the set of one or more virtual machines.
